(19) United States
(12) Patent Application Publication
(10) Pub. No.: US 2025/0013940 A1
(43) Pub. Date: Jan. 9, 2025

(54) INFORMATION PROCESSING APPARATUS, INFORMATION PROCESSING METHOD, AND STORAGE MEDIUM

(71) Applicant: NEC Corporation, Minato- ku, Tokyo (JP)

(72) Inventors: Hiromu IMURA, Tokyo (JP); Shinji NAKADAI, Tokyo (JP)

(73) Assignee: NEC Corporation, Minato- ku, Tokyo (JP)

(21) Appl. No.: 18/712,438

(22) PCT Filed: Nov. 30, 2021
(86) PCT No.: PCT/JP2021/043879

§ 371 Date: May 22, 2024

(51) Int. Cl. G06Q 10/047

(52) U.S. Cl. CPC G06Q 10/047

(57) ABSTRACT

Provided is an apparatus including: determination means (21) for determining a destination targeted for negotiation from among a plurality of destinations by solving a delivery planning problem including one or more constraint conditions, the one or more constraint conditions being associated with at least one of a capacity and a time window, the one or more constraint conditions being expressed by using a manipulated variable defined for each destination; and output means (22) for outputting information including a negotiation description for the destination determined by the determination means.

### TECHNICAL FIELD

The present invention relates to an information processing apparatus, an information processing method, and a program all of which are capable of generating a more efficient delivery plan by carrying out a flexible negotiation.

### BACKGROUND ART

Vehicle routing problem (VRP) are known as an optimization technique for obtaining the lowest cost route among possible routes visiting all customers by using a fleet of vehicles.

A delivery plan, which is generated by solving the VRP, is generated in consideration of a time window and a carrying capacity specified by each customer as constants. By considering the time window and the carrying capacity as variables and thereby relaxing constraints, it is possible to generate a more efficient delivery plan.

However, to change the time window and carrying capacity specified by a customer, it is naturally required to negotiate with the customer. There is a demand for a technique for easily proposing how to negotiate with which customer to generate a more efficient delivery plan.

Patent Literature 1 proposes a technique for determining a change condition candidate that is a candidate of a condition to be changed from either a sell condition or a buy condition.

### CITATION LIST

### Patent Literature

### [Patent Literature 1]

International Patent Application Publication No. WO2021/001978A1

### SUMMARY OF INVENTION

### Technical Problem

However, in Patent Literature 1, the same negotiation condition is presented to every negotiation target, so that, for example, when a negotiation is carried out to change the time window, there is a high probability that the negotiation will fail. Therefore, there is a need for a technique capable of generating a more efficient delivery plan by carrying out a more flexible negotiation.

An example aspect of the present invention has been made in view of this problem, and an example object thereof is to provide a technique for generating a more efficient delivery plan by carrying out a flexible negotiation.

### Solution to Problem

An information processing apparatus in accordance with an example aspect of the present invention includes: determination means for determining a destination targeted for negotiation from among a plurality of destinations by solving a delivery planning problem including one or more constraint conditions, the one or more constraint conditions being associated with at least one of a capacity and a time window, the one or more constraint conditions being expressed by using a manipulated variable defined for each destination; and output means for outputting information including a negotiation description for the destination determined by the determination means.

An information processing method in accordance with an example aspect of the present invention includes: determining a destination targeted for negotiation from among a plurality of destinations by solving a delivery planning problem including one or more constraint conditions, the one or more constraint conditions being associated with at least one of a capacity and a time window, the one or more constraint conditions being expressed by using a manipulated variable defined for each destination; and outputting information including a negotiation description for the determined destination.

A program in accordance with an example aspect of the present invention is a program for causing a computer to function as an information processing apparatus including: determination means for determining a destination targeted for negotiation from among a plurality of destinations by solving a delivery planning problem including one or more constraint conditions, the one or more constraint conditions being associated with at least one of a capacity and a time window, the one or more constraint conditions being expressed by using a manipulated variable defined for each destination; and output means for outputting information including a negotiation description for the destination determined by the determination means.

### Advantageous Effects of Invention

According to an example aspect of the present invention, it is possible to generate a more efficient delivery plan by carrying out a flexible negotiation.

### BRIEF DESCRIPTION OF DRAWINGS

FIG. 1 is a block diagram illustrating an example configuration of an information processing apparatus in accordance with a first example embodiment of the present invention.

FIG. 2 is a flowchart illustrating the flow of an information processing method in accordance with the first example embodiment of the present invention.

FIG. 3 is a block diagram illustrating an example configuration of a delivery plan generation apparatus 40 in accordance with a second example embodiment of the present invention.

FIG. 4 is a diagram for describing an example of a delivery plan.

FIG. 5 is a diagram for describing an example of a delivery plan generated by relaxing a constraint condition of a specified time window of the delivery plan.

FIG. 6 is a diagram for describing an example of a generated delivery plan reflecting a negotiation result.

FIG. 7 is a diagram for describing an example of another delivery plan generated by relaxing a constraint condition of a specified time window of the delivery plan.

FIG. 8 is a diagram for describing an example of a generated delivery plan reflecting a negotiation result.

FIG. 9 is a diagram illustrating an example of a delivery plan before being updated.

FIG. 10 is a diagram illustrating an example of a delivery plan obtained by updating the delivery plan of FIG. 9.

FIG. 11 is a diagram illustrating another example of the delivery plan before being updated.

FIG. 12 is a diagram illustrating an example of a delivery plan obtained by updating the delivery plan of FIG. 11.

FIG. 13 is a diagram illustrating yet another example of the delivery plan before being updated.

FIG. 14 is a diagram illustrating an example of a delivery plan obtained by updating the delivery plan of FIG. 13.

FIG. 15 is a diagram illustrating another example of the delivery plan obtained by updating the delivery plan of FIG. 13.

FIG. 16 is a diagram illustrating yet another example of the delivery plan obtained by updating the delivery plan of FIG. 13.

FIG. 17 is a diagram illustrating yet another example of the delivery plan before being updated.

FIG. 18 is a diagram illustrating an example of a delivery plan obtained by updating the delivery plan of FIG. 17.

FIG. 19 is a diagram for describing an example of a format for presenting a new specified time window that has been determined.

FIG. 20 is a diagram for describing an example of a format for presenting a new specified time window that has been determined.

FIG. 21 is a diagram for describing an example of a format for having a negotiation target select a new specified time window.

FIG. 22 is a diagram for describing an example of a format for having a negotiation target select a new specified time window.

FIG. 23 is a flowchart illustrating the flow of a delivery plan generation processing.

FIG. 24 is a diagram illustrating an example configuration of a computer that executes instructions of a program which is software realizing each function.

### EXAMPLE EMBODIMENTS

### First Example Embodiment

The following description will discuss a first example embodiment of the present invention in detail with reference to the drawings. The present example embodiment is basic to example embodiments that will be described later.

### <Outline of Information Processing Apparatus 20>

In brief, an information processing apparatus 20 in accordance with the present example embodiment is an apparatus that determines a destination needed to be negotiated, and outputs the destination needed to be negotiated and a negotiation description, in order to make a delivery plan more efficient.

More specifically, as an example, the information processing apparatus 20 may include:

by solving a delivery planning problem that includes a plurality of destinations and is associated with a relaxed constraint condition obtained by relaxing one or more constraint conditions associated with at least one of a capacity and a time window, by means of a parameter defined for each destination, determination means for determining a destination targeted for negotiation from among the plurality of g destinations; and

output means for outputting information including a negotiation description for the destination determined by the determination means.

### <Configuration of Information Processing Apparatus 20>

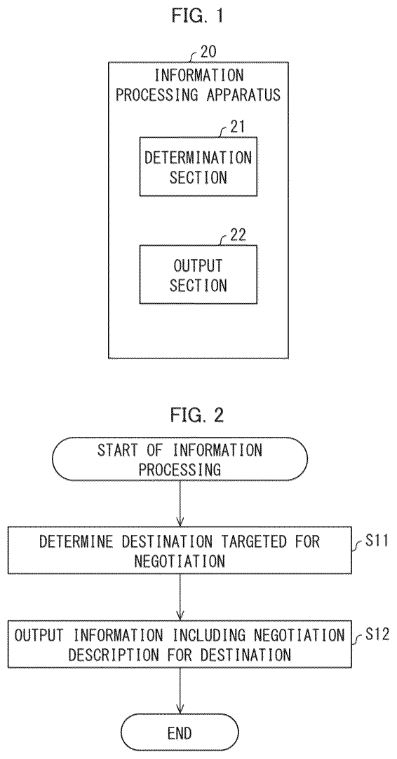

The following description will discuss the configuration of the information processing apparatus 20 in accordance with the present example embodiment with reference to FIG. 1. FIG. 1 is a block diagram illustrating an example configuration of the information processing apparatus 20.

As illustrated in FIG. 1, the information processing apparatus 20 includes a determination section 21 and an output section 22. The determination section 21 is configured to implement determination means in the present example embodiment. The output section 22 is configured to implement output means in the present example embodiment.

The determination section 21 determines a destination targeted for negotiation from among a plurality of destinations by solving a delivery planning problem including one or more constraint conditions, the one or more constraint conditions being associated with at least one of a capacity and a time window, the one or more constraint conditions being expressed by using a manipulated variable defined for each destination.

Alternatively, the determination section 21 may be configured to relax, in a delivery planning problem including a plurality of destinations, at least one of the one or more constraint conditions associated with at least one of a capacity and a time window by means of a manipulated variable defined for each destination. In this configuration, the determination section 21 determines a destination targeted for negotiation from among a plurality of destinations by solving the delivery planning problem associated with these constraint conditions. Here, some of these constraint conditions may be configured to include a relaxed constraint condition relaxed as described in the foregoing.

Here, the delivery planning problem is a problem needed to be solved to realize efficient delivery on the basis of a constraint condition or constraint conditions given in advance. Note that, although the term “delivery” is used herein, it is not necessarily limited to delivery of packages or the like. The delivery planning problem is an optimization problem with one or more constraint conditions associated with at least one of a capacity and a time window, and it refers to a general optimization problem in going around a plurality of target points (locations, customers, negotiation targets, etc.).

Herein, although each of the target points may be a delivery location and/or a pickup location of a package in real delivery planning, these locations will be collectively referred to as “destinations” to simplify descriptions.

The term “manipulated variable” refers to a variable to be manipulated in solving the delivery planning problem.

As an example, a delivery plan may show a route or routes in which all destinations are visited with use of a fleet of vehicles, as well as a time or a time slot in which a designated vehicle is scheduled to arrive at each destination. The delivery plan may be generated by, for example, a delivery company.

As an example, the delivery planning problem may be a vehicle routing problem (VRP), which is a problem of finding a route that minimizes an evaluation function under a given constraint condition. However, the evaluation function itself may include one or more constraint conditions, and the one or more constraint conditions may be considered.

In solving the VRP, a delivery time slot, a carrying capacity, and the like designated for each destination are given as parameters that cannot be specified by the delivery planner, so that they are given as constants in the constraint conditions. Such parameters will be referred to as specified parameters. The delivery time slot may also be referred to as a time window. In addition, the delivery time slot and the carrying capacity specified for each destination will be referred to as a specified time window and a specified capacity, respectively.

For example, minimizing the number of vehicles required for delivering packages or the like as much as possible provides an efficient delivery plan to the carrier.

The determination section 21 relaxes one or more constraint conditions associated with at least one of the capacity and the time window by means of a manipulated variable defined for each destination. For example, a constraint condition may be relaxed by changing a specified time window and/or a specified capacity.

Then, by solving the delivery planning problem associated with the relaxed constraint condition, the determination section 21 determines which specified time window and/or specified capacity of which destination is needed to be changed and how to change it in order to reduce the number of vehicles. This determines a destination that has a specified time window or a specified capacity needed to be changed as a negotiation target.

The output section 22 outputs information including a negotiation description for the destination determined by the determination section 21.

That is, the output section 22 outputs information including the destination targeted for negotiation and how to change the specified time window or the specified capacity of the targeted destination. The output section 22 may present this information to the destination targeted for negotiation.

### <Example Advantage of Information Processing Apparatus 20>

According to the information processing apparatus 20 in accordance with the present example embodiment, by solving a delivery planning problem that includes a plurality of destinations and is associated with a relaxed constraint condition obtained by relaxing one or more constraint conditions associated with at least one of a capacity and a time window, by means of a parameter defined for each destination, a destination targeted for negotiation is determined from among the plurality of destinations, and information including a negotiation description for the determined destination is outputted. In this way, it is possible to generate a more efficient delivery plan by carrying out a flexible negotiation.

### <Flow of Information Processing Method Carried Out by Information Processing Apparatus 20>

The following description will discuss the flow of an information processing method carried out by the information processing apparatus 20 configured as described in the foregoing, with reference to FIG. 2. FIG. 2 is a flowchart illustrating the flow of the information processing method. As illustrated in FIG. 2, the information processing includes steps S11 and S12.

In step S11, the determination section 21 determines a destination targeted for negotiation from among a plurality of destinations by solving a delivery planning problem including one or more constraint conditions associated with at least one of a capacity and a time window, the one or more constraint conditions being expressed by using a manipulated variable defined for each destination.

Alternatively, in step S11, the determination section 21 may be configured to relax, in a delivery planning problem including a plurality of destinations, at least one of the one or more constraint conditions associated with at least one of a capacity and a time window by means of a manipulated variable defined for each destination. In this configuration, the determination section 21 determines a destination targeted for negotiation from among a plurality of destinations by solving the delivery planning problem associated with these constraint conditions. Here, some of these constraint conditions may be configured to include a relaxed constraint condition relaxed as described in the foregoing.

In step S12, the output section 22 outputs information including a negotiation description for the determined destination.

### <Example Advantage of Information Processing Method>

According to the information processing method in accordance with the present example embodiment, by solving a delivery planning problem that includes a plurality of destinations and is associated with a relaxed constraint condition obtained by relaxing one or more constraint conditions associated with at least one of a capacity and a time window, by means of a manipulated variable defined for each destination, a destination targeted for negotiation is determined from among the plurality of destinations, and information including a negotiation description for the determined destination is outputted. In this way, it is possible to generate a more efficient delivery plan by carrying out a flexible negotiation.

### Second Example Embodiment

The following description will discuss a second example embodiment of the present invention in detail with reference to the drawings.

### <Delivery Plan Generation Apparatus 40>

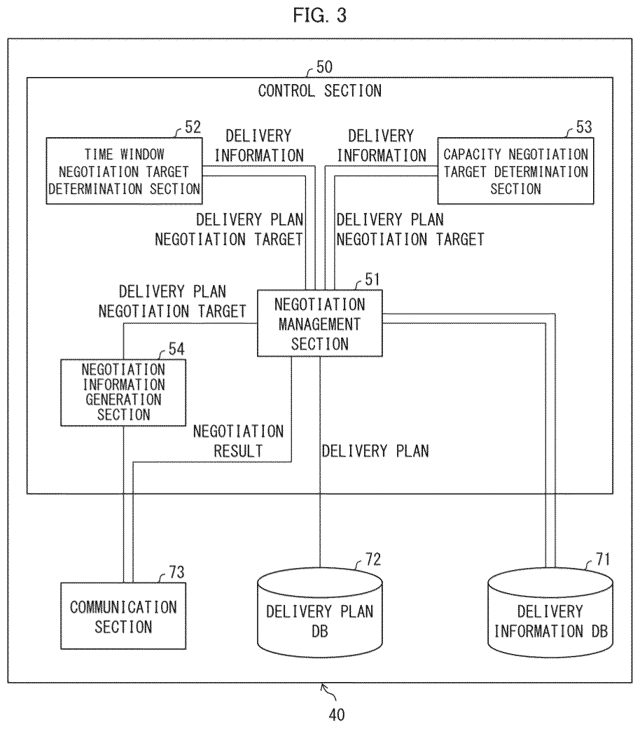

The following description will discuss the configuration of a delivery plan generation apparatus 40 in accordance with the present example embodiment with reference to FIG. 3. FIG. 3 is a block diagram illustrating an example configuration of the delivery plan generation apparatus 40.

As illustrated in FIG. 3, the delivery plan generation apparatus 40 includes a control section 50. The control section 50 includes a negotiation management section 51, a time window negotiation target determination section 52, a capacity negotiation target determination section 53, and a negotiation information generation section 54.

The negotiation management section 51, the time window negotiation target determination section 52, and the capacity negotiation target determination section 53 are functional blocks corresponding to the determination means in the first example embodiment. The negotiation information generation section 54 is a functional block corresponding to the output means in the first example embodiment.

The delivery plan generation apparatus 40 also includes a delivery information DB 71, a delivery plan DB 72, and a communication section 73, each of which is connected to the control section 50.

Each of the delivery information DB 71 and the delivery plan DB 72 is constituted by, for example, a semiconductor memory device and stores data.

The communication section 73 is an interface for connecting the delivery plan generation apparatus 40 to a network. Although a specific configuration of the network does not limit the present example embodiment, examples of the network may include a wireless local area network (LAN), a wired LAN, a wide area network (WAN), a public network, a mobile data communication network, and a combination of these networks.

### (Delivery Information DB and Delivery Plan DB)

In the example of FIG. 3, the delivery information DB 71 stores delivery information that is information such as an address of a destination, a specified time window, a specified capacity, a sender, and a receiver. For example, the delivery information may be stored in association with a delivery plan within the same area in the same time slot.

The delivery information DB 71 also stores information regarding negotiation with each destination.

For example, delivery information is stored like delivery information for preparing a delivery plan of December 1st for area X, delivery information for preparing a delivery plan of December 1st for area Y, delivery information for preparing a delivery plan of December 2nd for the area X, delivery information for preparing a delivery plan of December 2nd for the area Y, and the like.

The delivery plan DB 72 stores a delivery plan corresponding to the delivery information. For example, the delivery plan DB 72 stores delivery plans like a delivery plan of December 1st for the area X, a delivery plan of December 1st for the area Y, a delivery plan of December 2nd for the area X, and a delivery plan of December 2nd for the area Y.

The delivery plan is generated by solving the VRP with reference to the delivery information stored in the delivery information DB 71. The delivery plan may be generated by the delivery plan generation apparatus 40, or alternatively, a previously generated delivery plan may be used. In a case where the delivery plan is generated by the delivery plan generation apparatus 40, a VRP solving section may be provided, for example.

The VRP solving section generates a delivery plan by solving the VRP with reference to the delivery information stored in the delivery information DB 71. That is, the VRP solving section generates an evaluation function and one or more constraint conditions by using the information stored in the delivery information DB 71, and performs a calculation to derive a route that minimizes the evaluation function, to thereby generate a delivery plan. The VRP solving section stores the generated delivery plan in the delivery plan DB 72.

Further, the delivery plan may be separately prepared by, for example, the delivery company calculating a calculation formula.

Note that, the VRP is merely an example of the delivery planning problem; it is not intended to limit the vehicle routing problem the present example embodiment deals with.

### (Negotiation Management Section)

As will be described later, the negotiation management section 51 controls the time window negotiation target determination section 52, the capacity negotiation target determination section 53, and the negotiation information generation section 54, to cause each functional block to carry out a predetermined process. In addition, as will be described later, the negotiation management section 51 provides the negotiation information generation section 54 with a negotiation target and a new delivery plan provided from the time window negotiation target determination section 52 or the capacity negotiation target determination section 53. Further, the negotiation management section 51 receives a negotiation result via the communication section 73 and updates the delivery information based on the negotiation result.

### (Negotiation Information Generation Section)

The negotiation information generation section 54 generates negotiation information which is a time window or a carrying capacity needed to be presented to a negotiation target. As an example, the negotiation information may be generated as a GUI displayed on a display of a personal computer or a smartphone.

### (Time Window Negotiation Target Determination Section and Capacity Negotiation Target Determination Section)

The time window negotiation target determination section 52 and the capacity negotiation target determination section 53 generate an evaluation function with reference to delivery information, similarly to the VRP solving section, and perform a calculation to derive a route that minimizes the evaluation function, to thereby generate a delivery plan. However, the time window negotiation target determination section 52 and the capacity negotiation target determination section 53 are different in that they relax the constraint condition by means of a manipulated variable and perform a calculation to derive a route that minimizes the evaluation function under the relaxed constraint condition.

Here, relaxing a constraint condition is aimed to improve the efficiency of a delivery plan. As an example, increase in efficiency of a delivery plan reduces the number of vehicles required in the delivery plan.

The negotiation management section 51 provides the time window negotiation target determination section 52 and the capacity negotiation target determination section 53 with a delivery system plan stored in the delivery plan DB 72 and delivery information stored in the delivery information DB 71.

### (Processing of Time Window Negotiation Target Determination Section)

The time window negotiation target determination section 52 generates an evaluation function and one or more constraint conditions with reference to a delivery plan and delivery information. Then, the time window negotiation target determination section 52 relaxes the constraint condition by means of a manipulated variable related to a change in time window, and performs a calculation to derive a route that minimizes the evaluation function under the relaxed constraint condition, to thereby generate a new delivery plan.

At this time, the time window negotiation target determination section 52 determines, as a negotiation target, a destination that has a time window needed to be changed in order to relax the constraint condition.

As an example, the time window negotiation target determination section 52 selects, from among a plurality of destinations, a destination associated with at least one of constraint conditions expressed by using a manipulated variable defined for each destination, and determines the selected destination as the destination targeted for negotiation.

In other words, the time window negotiation target determination section 52 determines, from among a plurality of destinations, a destination associated with at least one of the relaxed constraint conditions, as the destination targeted for negotiation.

The negotiation target determined by the time window negotiation target determination section 52 is provided to the negotiation management section 51 together with the new delivery plan.

### (Processing of Capacity Negotiation Target Determination Section)

The capacity negotiation target determination section 53 generates an evaluation function and one or more constraint conditions with reference to the delivery plan and the delivery information. Then, the capacity negotiation target determination section 53 relaxes the constraint condition by means of a manipulated variable related to a change in carrying capacity, and performs a calculation to derive a route that minimizes the evaluation function under the relaxed constraint condition, to thereby generate a new delivery plan.

At this time, the capacity negotiation target determination section 53 determines, as a negotiation target, a destination that has a carrying capacity needed to be changed in order to relax the constraint condition.

As an example, the capacity negotiation target determination section 53 selects, from among a plurality of destinations, a destination associated with at least one of constraint conditions expressed by using a manipulated variable defined for each destination, and determines the selected destination as the destination targeted for negotiation.

In other words, the capacity negotiation target determination section 53 determines, from among a plurality of destinations, a destination associated with at least one of the relaxed constraint conditions, as the destination targeted for negotiation.

The negotiation target determined by the capacity negotiation target determination section 53 is provided to the negotiation management section 51 together with the new delivery plan.

### (Negotiation Information)

The negotiation management section 51 provides the negotiation generation section 54 with the negotiation target and the new delivery plan provided from the time window negotiation target determination section 52 or the capacity negotiation target determination section 53. The negotiation information generation section 54 generates negotiation information which is a time window or a carrying capacity needed to be presented to a negotiation target.

In a case where there are a plurality of negotiation targets determined by the time window negotiation target determination section 52 or the capacity negotiation target determination section 53, a time window or a carrying capacity needed to be presented to each negotiation target is generated as negotiation information.

For example, the negotiation information generated by the negotiation information generation section 54 may be sent to a person of the delivery company who is involved in the negotiation via the communication section 73. Alternatively, the negotiation information may be directly sent to the negotiation target via the communication section 73 as the GUI.

### (Reflecting Negotiation Result)

On the basis of the negotiation information generated by the negotiation information generation section 54, negotiation with a receiver at the destination is carried out. For example, when the receiver at the destination responds that the time window or the carrying capacity presented in the negotiation information is acceptable, this means that the negotiation is successful, whereas when the receiver responds that the proposal is unacceptable, this means that the negotiation fails. Such a negotiation result is received by the negotiation management section 51 via the communication section 73.

The negotiation management section 51 updates the delivery information based on the received negotiation result.

For example, when the time window presented in the negotiation information is accepted by the receiver at the destination, the negotiation management section 51 updates the specified time window stored in the delivery information DB 71 to the time window accepted by the receiver at the destination. More specifically, for example, the delivery information for generating the delivery plan of December 1st for the area X is updated so that the specified time window of destination A1 is changed from “10:00-11:00” to “12:00-13:00”.

Further, the VRP solving section generates a delivery plan by solving the VRP with reference to the latest updated delivery information and updates the delivery plan stored in the delivery plan DB 72. Alternatively, the delivery plan stored in the delivery plan DB 72 may be updated based on the delivery plan generated by the time window negotiation target determination section 52.

On the other hand, when the received negotiation result represents a negotiation failure, the negotiation management section 51 updates neither the distribution information nor the delivery plan.

Note that when the specified time window is updated, the constraint condition is also updated accordingly.

Further, for example, in a case where there are a plurality of negotiation targets, when all negotiations with the respective negotiation targets are successful, both the delivery information and the delivery plan may be updated, whereas when some negotiations with some negotiation targets fail, neither the delivery information nor the delivery plan may be updated.

Alternatively, in a case where there are a plurality of negotiation targets, when some negotiations with some negotiation targets are successful, the delivery information may be updated so that only the time windows specified by the some negotiation targets are updated, and the delivery plan may be updated based on the updated delivery information.

For example, in a case where there are a plurality of negotiation targets, the delivery information and the delivery plan may be updated every time a negotiation with one negotiation target is successful.

That is, the negotiation management section 51 obtains the negotiation result with the destination targeted for negotiation and updates the constraint condition corresponding to the negotiation result with reference to the negotiation result.

Further, the negotiation management section 51 stores, for example, negotiation success and failure information, which indicates success or failure in negotiation, in the delivery information DB 71 for each destination with reference to the negotiation result. More specifically, for example, as the negotiation success and failure information of the destination A1, stored is a negotiation success or a negotiation failure in the delivery plan of December 1st for the area X. Similarly, negotiation success and failure information of each of the other destinations A2, A3, and . . . is also stored.

Not only a success or failure in negotiation, but also a time required for a negotiation may be included in the negotiation success and failure information. Furthermore, information on, for example, a consideration such as a reward paid to the negotiation target, required for a negotiation may be included in the negotiation success and failure information.

When the delivery information of the delivery information DB 71 is updated due to success in negotiation, the negotiation management section 51 provides the updated delivery information to the time window negotiation target determination section 52 or the capacity negotiation target determination section 53.

The time window negotiation target determination section 52 generates an evaluation function and one or more constraint conditions with reference to the updated delivery information. Then, the time window negotiation target determination section 52 further relaxes the constraint condition by means of a manipulated variable related to a change in time window, and performs a calculation to derive a route that minimizes the evaluation function under the relaxed constraint condition, to thereby generate a new delivery plan and determine a new negotiation target.

At this time, the negotiation management section 51 refers to information regarding a negotiation with the destination in the delivery information DB 71, and controls the time window negotiation target determination section 52 so that a destination with which a negotiation has already failed is not determined to be a new negotiation target. Alternatively, a destination with which a negotiation has already failed may be allowed to be determined to be a new negotiation target. In this case, for example, in a new negotiation, a time window different from a time window that has already presented in the failed negotiation may be presented.

Similarly, the capacity negotiation target determination section 53 generates a new delivery plan and determines a new negotiation target. At this time, the capacity negotiation target determination section 53 determines, as a new negotiation target, a destination that has a carrying capacity needed to be changed in order to relax the constraint condition.

At this time, the negotiation management section 51 refers to information regarding a negotiation with the destination in the delivery information DB 71, and controls the capacity negotiation target determination section 53 so that a destination with which a negotiation has already failed is not determined to be a new negotiation target. Alternatively, a destination with which a negotiation has already failed may be allowed to be determined to be a new negotiation target. In this case, for example, in a new negotiation, a carrying capacity different from a time window that has already presented in the failed negotiation may be presented.

On the basis of the result of the processing carried out by the time window negotiation target determination section 52 or the capacity negotiation target determination section 53, the negotiation information generation section 54 generates negotiation information which is a time window or a carrying capacity needed to be presented to the new negotiation target.

The negotiation management section 51 repeats the foregoing processing until the time window negotiation target determination section 52 or the capacity negotiation target determination section 53 determine that there is no negotiation target.

The negotiation management section 51 may carry out a check as to a delivery start time. For example, the negotiation management section 51 may forcibly terminate the processing 30 minutes before the delivery start time.

The VRP solving section generates a final delivery plan by solving the VRP with reference to the latest updated delivery information and updates the delivery plan stored in the delivery plan DB 72. Alternatively, the delivery plan stored in the delivery plan DB 72 may be updated based on the delivery plan generated by the time window negotiation target determination section 52 or the capacity negotiation target determination section 53.

### (Generating Delivery Plan)

The delivery plan can be expressed as a selection of ordered edges on an effective graph G. The effective graph is expressed by G=(V, A).

V is expressed by V=PUDU {0,2n+1}, and is a set of all vertices on the effective graph G.

P={1, . . . , n}, where P is a set of vertices at which packages are picked up.

D={n+1, . . . , 2n}, where D is a set of vertices to which packages are delivered.

Here, {0, 2n+1} is the starting and ending point of delivery; this may correspond to, for example, a depot. Here, multiple depots may be included a delivery plan.

A is expressed by A={(i, j)∈V×V|i≠j}, and is a set of edges on the effective graph G.

In the following description, cᵢⱼ ((i,j)∈A) indicates a traveling cost from vertex i to vertex j.

tᵢⱼ ((i, j)∈A) indicates a travel time from vertex i to vertex j.

K={1, . . . , | K|}, where K denotes an available vehicle.

Qₖ denotes the maximum payload capacity (carrying capacity) of vehicle k, and

Lₖ denotes the maximum working hours of vehicle k.

qᵢ and sᵢ represent specified parameters regarding the carrying capacity and servicing hours.

qᵢ denotes the carrying capacity to be delivered from vertex i to vertex n+1.

Where qₙ₊₁=−qᵢ, i=1, . . . , n, q₀=q₂ₙ₊₁=0.

sᵢ denotes servicing hours at vertex i.

Where s₀=s₂ₙ₊₁=0.

Further, [aᵢ, bᵢ] represents a specified parameter regarding a time window, which indicates a time window at vertex i.

### (Formulation of Delivery Planning Problem)

(Case where Time Window is Used as Manipulated Parameter)

Expression M1 shows an evaluation function for use in calculation in the time window negotiation target determination section 52.

$$minimize \text{?} \qquad ( Expression M1 )$$

$$\text{?} \text{indicates text missing or illegible when filed}$$

Constraint conditions given in calculation of deriving a path that minimizes Expression M1 are as follows.

$$subject to$$

$$\text{?} \{ ( 1 - \text{?} ) \text{?} + ( 1 - \text{?} ) \text{?} \} \geq {δ}^{′}$$

$$\text{?} = 1 ∀ i ∈ P ,$$

$$\text{?} - \text{?} = 0 ∀ i ∈ P , k ∈ K ,$$

$$\text{?} = 1 ∀ k ∈ K ,$$

$$\text{?} = 0 ∀ k ∈ K ,$$

$$\text{?} - \text{?} = 0 ∀ i ∈ P ⋃ D , k ∈ K ,$$

$$\text{?} = 1 ∀ k ∈ K ,$$

$$\text{?} \geq ( \text{?} + {s}_{i} + \text{?} ) \text{?} ∀ i ∈ V , j ∈ V , k ∈ K ,$$

$$\text{?} - \text{?} - {s}_{i} - \text{?} \geq 0 ∀ i ∈ P ,$$

$$\text{?} - \text{?} \leq \text{?} ∀ k ∈ K ,$$

$$\text{?} - \text{?} \leq \text{?} \leq \text{?} + \text{?} ∀ i ∈ V , k ∈ K ,$$

$$\text{?} ∈ \{ 0 , 1 \} ∀ i ∈ V , j ∈ V , k ∈ K .$$

$$\text{?} \text{indicates text missing or illegible when filed}$$

The meaning of each of the variables in the above Expression M1 and the constraint conditions is as follows.

xᵢⱼₖ(i ∈V,j∈V,k∈K):

whether or not vehicle k passes along edge (i, j)

Tᵢₖ(i∈V,k∈K):

service start time of vehicle k at vertex i

yᵢ^{a}(i∈D):

whether or not the lower limit of the time window of negotiation target candidate i is needed to be changed

yᵢ^{b}(i∈D):

whether or not the upper limit of the time window of negotiation target candidate i is needed to be changed

Each of the vertices i and j corresponds to a destination. The servicing hours means an amount of time spent stopping driving of a vehicle due to loading and unloading of packages or the like at the vertex (i.e., destination).

Note that only one of yᵢ^{a} and yᵢ^{b} in the abovementioned constraint conditions may be used.

Further,

$${\sum }_{i ∈ V} \{ ( 1 - \text{?} ) \text{?} + ( 1 - {y}_{i}^{b} ) {p}_{i}^{b} \} \geq {δ}^{′}$$

$$\text{?} \text{indicates text missing or illegible when filed}$$

in the constraint conditions indicates a constraint regarding a negotiation target. Here, pᵢ denotes the probability of success in negotiation with vertex i.

Furthermore,

$${a}_{i} - \text{?} \leq \text{?} \leq {b}_{i} + \text{?} ∀ i ∈ V , k ∈ K ,$$

$$\text{?} \text{indicates text missing or illegible when filed}$$

included in the above constraint conditions is one or more constraint conditions regarding a time window, the one or more constraint conditions including manipulated variables yᵢ^{a} and yᵢ^{b} defined for each destination. This constraint condition may also be expressed as a relaxed constraint condition in which the specified time window is relaxed, compared to a constraint condition yᵢ^{a}≤Tᵢₖ≤yᵢ^{b} in which no terms of the manipulated variables yᵢ^{a} and yᵢ^{b} are included.

Here, among the left-hand side, the middle, and the right-hand side in the abovementioned constraint condition, the lower limit of the time window is further lowered by the term [−wᵢ^{a}yᵢ^{a}] on the left-hand side, and the term [+wᵢ^{a}yᵢ^{a}] on the right-hand side further raises the upper limit of the time window, so as to relax the specified time window. Under this relaxed constraint condition, a calculation that derives a route that minimizes the evaluation function is performed.

Further, the change width of the specified time window may be given as a variable in the abovementioned constraint condition.

That is, the meaning of each variable of the constraint conditions may be determined as follows.

xᵢⱼₖ(i∈V,j∈V,k∈K);
whether or not vehicle k passes along edge (i, j)

Tᵢₖ(i∈V,k∈K):

service start time of vehicle k at vertex i

yᵢ^{a}(i∈V):

whether or not the lower limit of the time window of negotiation target candidate i is needed to be changed

yᵢ^{b}(i∈V):

whether or not the upper limit of the time window of negotiation target candidate i is needed to be changed

wᵢ^{a}(i∈V)):

time to which the lower limit of the time window of negotiation target candidate i is changed

wᵢ^{b}(i∈V)):

time to which the upper limit of the time window of negotiation target candidate i is changed

In this way, for example, it is possible to carry out negotiation, proposing a different time window for each destination.

Here, the evaluation function may include a variable regarding yᵢ. That is, the evaluation function itself may include some of the constraint conditions, and the constraint conditions may be considered.

In this case, the evaluation function is expressed as in Expression M2.

$$minimize \text{?} + \text{?} + \text{?} \qquad ( Expression M2 )$$

$$\text{?} \text{indicates text missing or illegible when filed}$$

(Case where Carrying Capacity is Used as Manipulated Parameter)

Expression M3 shows an evaluation function for use in calculation in the capacity negotiation target determination section 53.

$$minimize \text{?} {\sum }_{i ∈ V} {\sum }_{j ∈ V} {c}_{ij} \text{?} \qquad ( Expression M3 )$$

$$\text{?} \text{indicates text missing or illegible when filed}$$

Constraint conditions given in calculation of deriving a path that minimizes Expression M1 are as follows.

$$subject to$$

$$\text{?} \{ ( 1 - {y}_{i} ) {p}_{i} \} \geq \text{?}$$

$$\text{?} = 1 ∀ i ∈ P ,$$

$$\text{?} - \text{?} = 0 ∀ i ∈ P , k ∈ K ,$$

$$\text{?} = 1 ∀ k ∈ K ,$$

$$\text{?} = 0 ∀ k ∈ K ,$$

$$\text{?} - \text{?} = 0 ∀ i ∈ P ⋃ D , k ∈ K ,$$

$$\text{?} = 1 ∀ k ∈ K ,$$

$$\text{?} \geq ( \text{?} + \text{?} + \text{?} ) \text{?} ∀ i ∈ V , j ∈ V , k ∈ K ,$$

$$max \{ 0 , \text{?} + \text{?} \} \leq \text{?} \leq min \{ \text{?} , \text{?} + \text{?} + \text{?} \} ∀ i ∈ V , k ∈ K ,$$

$$\text{?} ∈ \{ 0 , 1 \} ∀ i ∈ V , j ∈ V , k ∈ K .$$

$$\text{?} \text{indicates text missing or illegible when filed}$$

The meaning of each of the variables in the above Expression M3 and the constraint conditions is as follows.

xᵢⱼₖ(i∈V,j∈V,k∈K):

whether or not vehicle k passes along edge (i, j)

Qᵢₖ(i∈V,k∈K);

payload capacity of vehicle k after vehicle k arrives at vertex i

yᵢ(i∈D):

whether or not the carrying capacity of negotiation target candidate i is needed to be changed

Each of the vertices i and j corresponds to a destination.

Further,

$$subject to$$

$$\text{?} \{ ( 1 - {y}_{i} ) {p}_{i} \} \geq {δ}^{′}$$

$$\text{?} \text{indicates text missing or illegible when filed}$$

in the constraint conditions indicates a constraint regarding a negotiation target.

Furthermore,

$$max \{ 0 , {q}_{i} + {w}_{i} {y}_{i} \} \leq \text{?} \leq min \{ \text{?} , \text{?} + {q}_{i} + {w}_{i} {y}_{i} \} ∀ i ∈ V , k ∈ K ,$$

$$\text{?} \text{indicates text missing or illegible when filed}$$

included in the above constraint conditions is one or more constraint conditions regarding a carrying capacity, the one or more constraint conditions including a manipulated variable yᵢ defined for each destination. This constraint condition may also be expressed as a relaxed constraint condition in which the specified capacity is relaxed, compared to a constraint condition in which no term of the manipulated variable yᵢ is included.

Thus, one or more constraint conditions may include only a constraint condition regarding the capacity, out of the capacity and the time window.

Here, the evaluation function may include a variable regarding yᵢ. That is, the evaluation function itself may include some of the constraint conditions, and the constraint conditions may be considered.

In this case, the evaluation function is expressed as in Expression M4.

$$minimize \text{?} {\sum }_{i ∈ V} {\sum }_{j ∈ V} {c}_{ij} \text{?} + {\sum }_{i ∈ V} {c}_{i} {y}_{i} \qquad ( Expression M4 )$$

$$\text{?} \text{indicates text missing or illegible when filed}$$

(Case where Constraint Condition Regarding Negotiation Target are Included)

The delivery planning problem solved by the time window negotiation target determination section 52 and the capacity negotiation target determination section 53 may include an evaluation function or a constraint condition including information that is associated with at least one of the plurality of destinations and is other than the capacity or the time window.

For example, the time window negotiation target determination section 52 and the capacity negotiation target determination section 53 may further perform a calculation for minimizing the evaluation function, including the probability of success (or failure) in negotiation with the destination in the constraint condition.

For example, a constraint may be imposed that the probability of success in negotiation with the destination is not less than a reference value M. This constraint can be expressed by Expression M5, assuming that the probability of success in negotiation with vertex i is pᵢ.

$$( Expression M5 )$$

$$\begin{matrix}\text{?} \geq M ⇔ \text{?} ( 1 - {y}_{i} ) log {p}_{i} \geq log M \\ ⇔ \text{?} log {p}_{i} \leq - log M + \text{?} log {p}_{i}\end{matrix}$$

$$\text{?} \text{indicates text missing or illegible when filed}$$

The probability of success in negotiation with each destination may be determined by referring to negotiation success and failure information stored in the delivery information DB 71, for example.

Thus, the constraint condition may include a constraint regarding a probability of success in negotiation with a negotiation target. Further, the evaluation function itself may include this constraint condition, and the constraint condition may be considered. In this case, by appropriately giving a weighting factor, it is possible to perform a calculation for finding a negotiation target having a highest possible negotiation success rate while minimizing the original evaluation function.

Alternatively, the time window negotiation target determination section 52 and the capacity negotiation target determination section 53 may further perform a calculation for minimizing the evaluation function, including a time required for negotiation with the destination in the constraint condition.

For example, a constraint may be imposed that a time required for a negotiation with the destination is not less than a reference value M. This constraint can be expressed by Expression M6, assuming that an amount of time uᵢ estimated to be required until a negotiation with vertex i is terminated.

$$\text{?} {y}_{i} \leq M ⇔ \text{?} {y}_{i} \leq M , ∀ i \qquad ( Expression M6 )$$

$$\text{?} \text{indicates text missing or illegible when filed}$$

The amount of time estimated to be required until a negotiation with each destination is terminated may be determined by referring to negotiation success and failure information stored in the delivery information DB 71, for example. In this case, it is assumed that the negotiation success and failure information includes the time required for the negotiation.

Thus, the constraint condition may include a constraint regarding a time required for a negotiation with a negotiation target. Further, the evaluation function itself may include this constraint condition, and the constraint condition may be considered. In this case, by appropriately giving a weighting factor, it is possible to perform a calculation for finding a negotiation target having a shortest possible time estimated to be required for a negotiation while minimizing the original evaluation function.

Alternatively, the time window negotiation target determination section 52 and the capacity negotiation target determination section 53 may further perform a calculation for minimizing the evaluation function, including a consideration required for negotiation with the destination in the constraint condition.

For example, a constraint may be imposed that a consideration required for a negotiation with the destination is not less than a reference value M. This constraint can be expressed by Expression M7 when sᵢ is a consideration that should be paid by the delivery company when a negotiation with vertex i is successful.

$$\text{?} {y}_{i} \leq M \qquad ( Expression M7 )$$

$$\text{?} \text{indicates text missing or illegible when filed}$$

The consideration required for a negotiation with each destination may be determined by referring to negotiation success and failure information stored in the delivery information DB 71, for example. In this case, it is assumed that the negotiation success and failure information includes a consideration required for a negotiation.

Thus, the constraint condition may include a constraint regarding a consideration required for a negotiation with a negotiation target. Further, the evaluation function itself may include this constraint condition, and the constraint condition may be considered. In this case, by appropriately giving a weighting factor, it is possible to perform a calculation for finding a negotiation target requiring a lowest possible consideration estimated to be required for a negotiation while minimizing the original evaluation function.

### (How to Determine Negotiation Target)

Next, the following description will describe how the time window negotiation target determination section 52 and the capacity negotiation target determination section 53 determine a negotiation target.

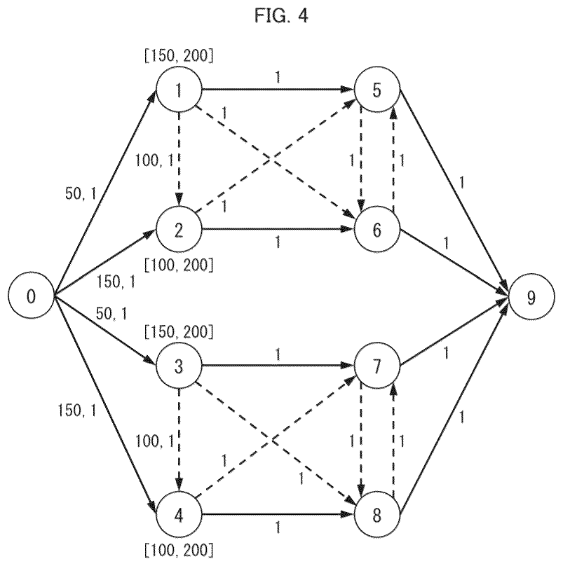

FIG. 4 is a diagram for describing an example of a delivery plan. For example, the delivery plan of FIG. 4 may be a delivery plan generated by the VRP solving section. In this figure, each of circled numerals of 0 to 9 indicates a vertex, that is, a destination.

The vertex “0” corresponds to, for example, a depot and may be a departure point at which vehicles that are needed for delivery start. The vertex “9” is an ultimate destination point at which the vehicles needed for delivery end. In this example, eight destinations at vertices “1” to “8” exist on paths from the vertex “0” to the vertex “9”.

Further, in this figure, each arrow connecting vertices represents a path along which a vehicle travels. Here, each solid arrow indicates a path along which a vehicle travels in the delivery plan, and a dashed arrow indicates a path along which no vehicle travels in the delivery plan.

In this example, four vehicles start from the vertex “0” simultaneously. The first vehicle travels through the vertices “1” and “5”, and then reaches the vertex “9”. The second vehicle travels through the vertices “2” and “6”, and then reaches the vertex “9”. The third vehicle travels through the vertices “3” and “7”, and then reaches the vertex “9”. The fourth vehicle travels through the vertices “4” and “8”, and then reaches the vertex “9”.

Arrows connecting vertices are accompanied with numerical values that represent an amount of time required for traveling from the starting point to the ending point of each path indicated by the arrow thereof, and a cost of the path.

In this example, arrows between the vertex “0” and each of the vertices “1” to “4”, an arrow between the vertices “1” and “2”, and an arrow between the vertices “3” and “4” are accompanied with both times and costs, and the remaining arrows are accompanied with costs only. For example, “50, 1” added along the arrow between the vertices “0” and “1” indicates that the time required from the starting point to the ending point of the path is 50 and the cost of the path is 1.

The numerical values shown in brackets for each of the vertices “1” to “4” represent specified time windows of the respective vertices. For example, [150, 200], shown together with the vertex “1”, indicates that the lower limit of the specified time window is time 150 and the upper limit is time 200.

In this example, for simplicity of description, it is assumed that there is no specified time window at the vertices “5” to “8”.

The VRP solving section selects paths through which the vehicles travel in such a manner as to minimize the sum of the costs of all the paths while satisfying the constraints of the specified time windows.

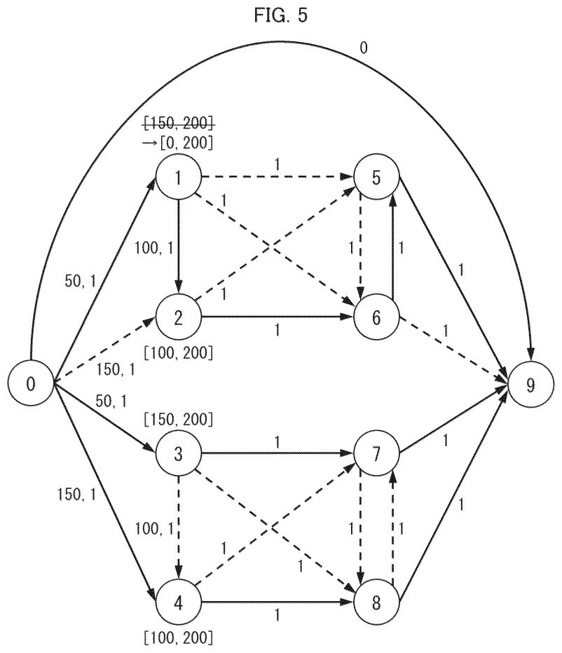

FIG. 5 is a diagram for describing an example of a delivery plan generated by relaxing a constraint condition of a specified time window of the delivery plan. Here, an example in which the number of vehicles required for delivery is reduced by negotiation will be described.

As described above, the time window negotiation target determination section 52 relaxes the constraint condition of the specified time window of the delivery plan illustrated in FIG. 4 by means of the manipulated variable. For example, to reduce the number of vehicles, the time window negotiation target determination section 52 may add a virtual path directly connecting the vertex “0” and the vertex “9” to the delivery plan of FIG. 4, and set the cost of this virtual path to 0, which is the smallest cost.

In this state, the time window negotiation target determination section 52 selects paths illustrated in FIG. 5 as a route required to minimize the evaluation function.

In the example of FIG. 5, the first vehicle passes along a virtual path directly connecting the vertex “0” to the vertex “9”. The second vehicle starts at the vertex “0” and travels through the vertex “1”, the vertex “2”, the vertex “6”, and the vertex “5”, and then reaches the vertex “9”. Here, the lower limit of the specified time window of the vertex “1” has been changed so that the specified time window of the vertex “1” is set to [0, 200]. The third vehicle starts at the vertex “0” and travels through the vertex “3” and the vertex “7”, and then reaches the vertex “9”. The fourth vehicle starts at the vertex “0” and travels through the vertex “4” and the vertex “8”, and then reaches the vertex “9”.

In this case, the time window negotiation target determination section 52 determines the destination corresponding to the vertex “1” as the negotiation target.

Here, since the virtual path does not exist actually, no vehicle is required to pass along the virtual path. That is, if the lower limit of the specified time window of the vertex “1” could be changed to time 0, it is possible to reduce the number of vehicles by one with respect to the delivery plan of FIG. 4.

Thus, the negotiation information generation section 54 generates the negotiation information, [0, 200], which is a time window needed to be presented to the destination corresponding to the vertex “1”.

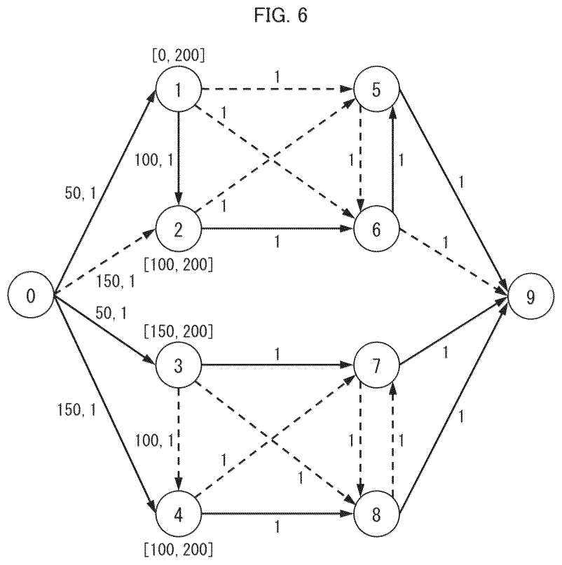

FIG. 6 is a diagram for describing an example of a generated delivery plan reflecting a negotiation result. In the delivery plan illustrated in FIG. 6, the number of vehicles required for delivery is three.

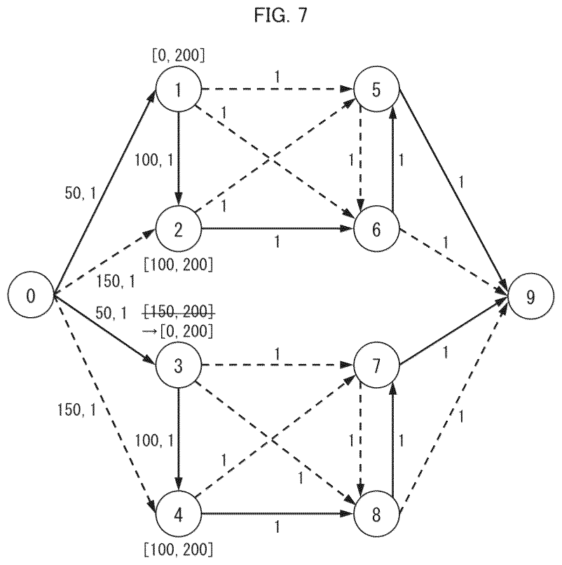

FIG. 7 is a diagram for describing an example of another delivery plan generated with a relaxed constraint condition of a specified time window of the delivery plan. Here, an example will be described in which the number of vehicles required for delivery is further reduced by negotiation based on the delivery plan illustrated in FIG. 6.

The time window negotiation target determination section 52 relaxes the constraint condition of the specified time window of the delivery plan illustrated in FIG. 6 by means of the manipulated variable. Similarly to the case described above with reference to FIG. 5, to reduce the number of vehicles, the time window negotiation target determination section 52 may add, for example, a virtual path directly connecting the vertex “0” and the vertex “9” to the delivery plan of FIG. 6, and set the cost of this virtual path to 0, which is the smallest cost.

In this state, the time window negotiation target determination section 52 selects paths illustrated in FIG. 7 as a route required to minimize the evaluation function.

In the example of FIG. 7, the first vehicle starts at the vertex “0” and travels through the vertex “1”, the vertex “2”, the vertex “6”, and the vertex “5”, and then reaches the vertex “9”. The second vehicle starts at the vertex “0” and travels through the vertex “3”, the vertex “4”, the vertex “7”, and the vertex “8”, and then reaches the vertex “9”. Here, the lower limit of the specified time window of the vertex “3” has been changed so that the specified time window of the vertex “1” is set to [0, 200]. Also in this case, no vehicle is required to pass along the virtual path (not illustrated).

In this case, the time window negotiation target determination section 52 determines the destination corresponding to the vertex “3” as the negotiation target.

That is, if the lower limit of the specified time window of the vertex “3” could be changed to time 0, it is possible to further reduce the number of vehicles by one with respect to the delivery plan of FIG. 6.

Thus, the negotiation information generation section 54 generates the negotiation information, [0, 200], which is a time window needed to be presented to the destination corresponding to the vertex “3”.

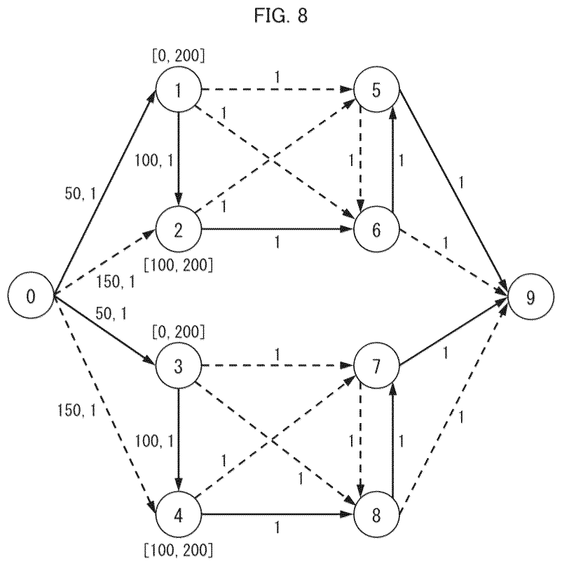

FIG. 8 is a diagram for describing an example of a generated delivery plan reflecting a negotiation result. In the delivery plan illustrated in FIG. 8, the number of vehicles required for delivery is two.

Even when any of the constraint conditions of the specified time windows of the delivery plan illustrated in FIG. 8 is relaxed, the number of vehicles cannot be further reduced, so that the time window negotiation target determination section 52 cannot determine another negotiation target. Therefore, the delivery plan illustrated in FIG. 8 is regarded as a finalized delivery plan.

### (Updating Delivery Plan)

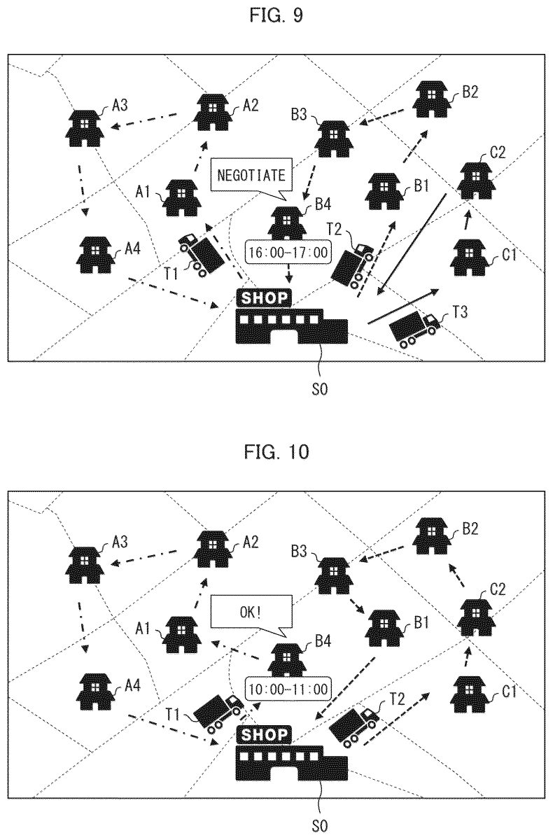

Each of FIGS. 9 to 18 is a diagram for describing an example of an update on a delivery plan.

FIG. 9 is a diagram illustrating an example of a delivery plan before being updated. In this example, a driver of vehicle T1 visits destinations A1 to A4 and returns to depot S0. Further, a driver of vehicle T2 visits destinations B1 to B4 and returns to the depot S0. Further, a driver of vehicle T3 visits destinations C1 to C2 and returns to the depot S0.

At that time, the specified time window of the destination B4 has a lower limit of 16:00 and an upper limit of 17:00. In this example, to reduce the number of vehicles, a negotiation with a receiver at the destination B4 is carried out based on negotiation information generated by the negotiation information generation section 54.

FIG. 10 is a diagram illustrating an example of a delivery plan obtained by updating the delivery plan of FIG. 9. In this example, the negotiation with the receiver at the destination B4 has succeeded, and the specified time window of the destination B4 has been changed so as to have a lower limit of 10:00 and an upper limit of 11:00. This reduces the number of vehicles required for the delivery plan by one, resulting in two vehicles required.

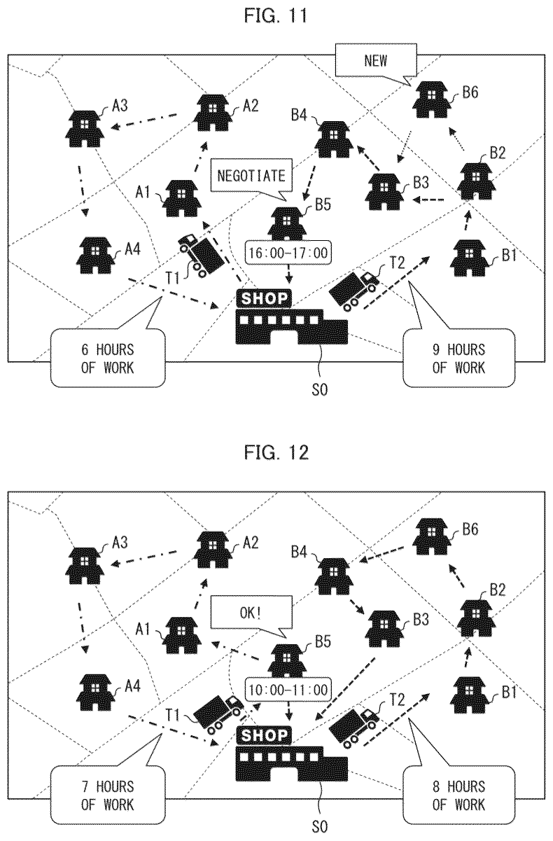

FIG. 11 is a diagram illustrating another example of the delivery plan before being updated. In this example, a driver of vehicle T1 visits destinations A1 to A4 and returns to depot SO. Further, a driver of vehicle T2 visits destinations B1 to B6 and returns to the depot SO. Here, the destination B6 is newly added.

Typically, the delivery plan is generated on condition that the working hours of the driver of each vehicle is within eight hours. However, in the example of FIG. 11, since the destination B6 is added, the working hours of the driver of the vehicle T2 reaches 9 hours.

At that time, the specified time window of the destination B5 has a lower limit of 16:00 and an upper limit of 17:00. In this example, to reduce the working hours of the driver of the vehicle T2, a negotiation with a receiver at the destination B5 is carried out based on negotiation information generated by the negotiation information generation section 54.

FIG. 12 is a diagram illustrating an example of a delivery plan obtained by updating the delivery plan of FIG. 11. In this example, the negotiation with the receiver at the destination B5 has succeeded, and the specified time window of the destination B5 has been changed so as to have a lower limit of 10:00 and an upper limit of 11:00. This reduces the working hours of the driver of the vehicle T2 to eight hours.

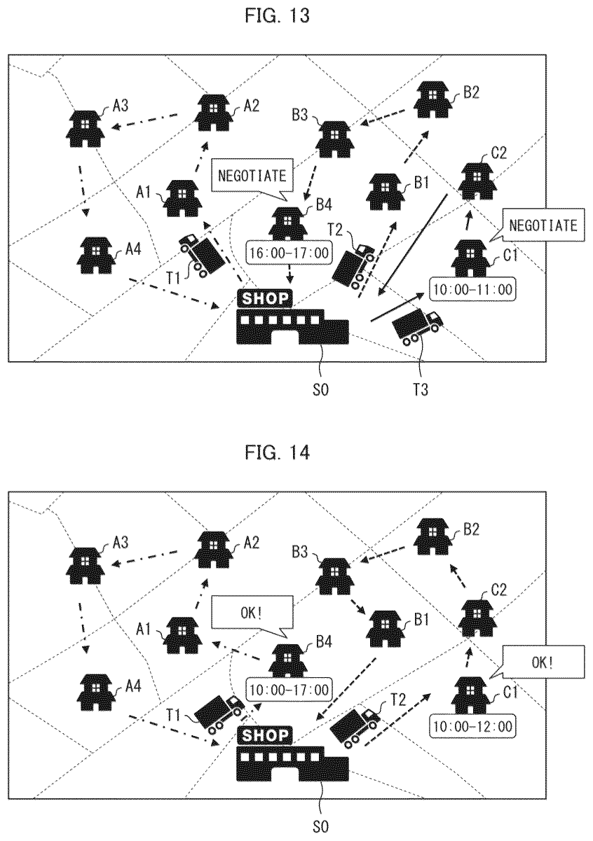

FIG. 13 is a diagram illustrating yet another example of the delivery plan before being updated. In this example, a driver of vehicle T1 visits destinations A1 to A4 and returns to depot SO. Further, a driver of vehicle T2 visits destinations B1 to B4 and returns to the depot SO. Further, a driver of vehicle T3 visits destinations C1 to C2 and returns to the depot SO.

At that time, the specified time window of the destination B4 has a lower limit of 16:00 and an upper limit of 17:00. The specified time window of the destination C1 has a lower limit of 10:00 and an upper limit of 11:00. In this example, to reduce the number of vehicles, negotiations with a receiver at the destination B4 and a receiver at the destination C1 are carried out based on negotiation information generated by the negotiation information generation section 54.

FIG. 14 is a diagram illustrating an example of a delivery plan obtained by updating the delivery plan of FIG. 13. In this example, the negotiation with the receiver at the destination B4 has succeeded, and the specified time window of the destination B4 has been changed so as to have a lower limit of 10:00 and an upper limit of 17:00. In addition, the negotiation with the receiver at the destination C1 has succeeded, and the specified time window of the destination C1 has been changed so as to have a lower limit of 10:00. This reduces the number of vehicles required for the delivery plan by one, resulting in two vehicles required.

Thus, the negotiations with multiple destinations may be carried out at the same time, and the delivery plan may be updated when all of the negotiations succeeds.

Note that, in the example of FIG. 10, the original specified time window of the destination B4 is one hour, and the changed specified time window is also one hour. On the other hand, in the example of FIG. 14, the original specified time window of the destination B4 is one hour, and the changed specified time window is five hours. Thus, the specified time window presented to a receiver at a destination in negotiation may be a time window obtained by widening the time slot such that the time slot always includes the original specified time window. In this way, for example, it is expected that a negotiation with a receiver at a destination is more likely to be successful as compared to a case where a completely different time window is presented.

Alternatively, the specified time window to be presented to a receiver at a destination in negotiation may be a time window obtained by narrowing the time slot in such a manner that the time slot is always included in the original specified time window. For example, a case where a time window having a lower limit of 16:00 and an upper limit of 16:40 is presented to a driver at the destination B4 corresponds to such a case where a time window obtained by narrowing the time slot in such a manner that the time slot is always included in the original specified time window.

Further, in each example of FIGS. 10, 12, and 14, an example has been described in which a negotiation with a receiver at a destination is carried out by presenting a new time window having the lower limit and/or the upper limit changed from those of the original specified time window. However, multiple time windows may be presented to the receiver at the destination for negotiation.

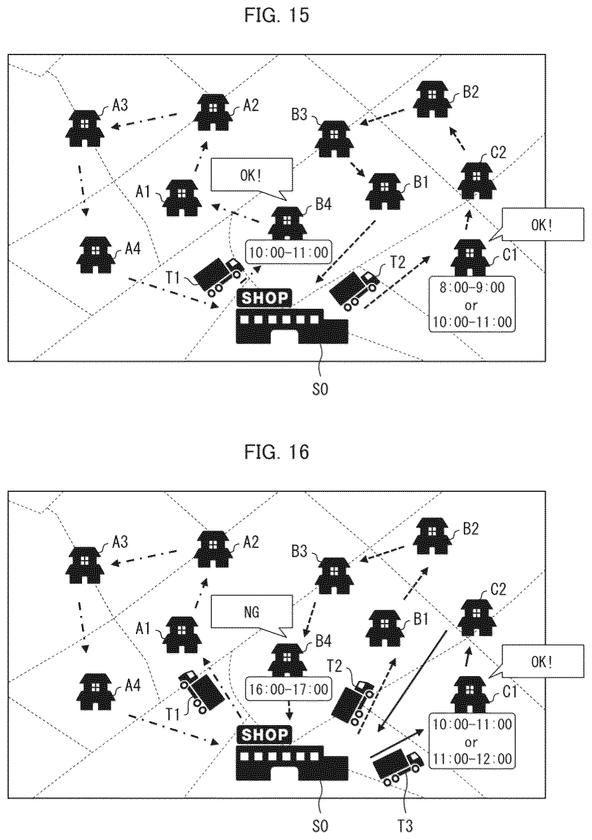

FIG. 15 is a diagram illustrating another example of the delivery plan obtained by updating the delivery plan of FIG. 13. In the case of FIG. 15, unlike the example of FIG. 14, the specified time window of the destination C1 is a time window having a lower limit of 8:00 and an upper limit of 9:00, or a time window having a lower limit of 10:00 and an upper limit of 11:00. Again, this reduces the number of vehicles required for the delivery plan by one, resulting in two vehicles required.

FIG. 16 is a diagram illustrating yet another example of the delivery plan obtained by updating the delivery plan of FIG. 13. In the case of FIG. 16, unlike the example of FIG. 15, the negotiation with the receiver at the destination B4 has been failed, and the specified time window of the destination B4 remains to have a lower limit of 16:00 and an upper limit of 17:00. In contrast, the negotiation with the receiver at the destination C1 has succeeded, and the specified time window of the destination C1 is changed to a time window having a lower limit of 8:00 and an upper limit of 9:00, or a time window having a lower limit of 10:00 and an upper limit of 11:00.

In such a case, the delivery plan may be updated by changing only the specified time window of the destination C1. In this case, the number of vehicles required in the delivery plan cannot be reduced, but there is no need to further change the specified time window that has been changed by negotiation.

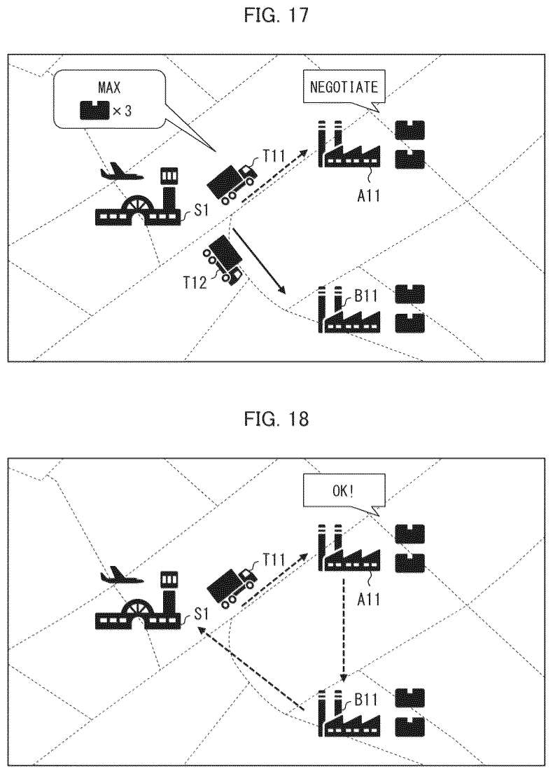

FIG. 17 is a diagram illustrating yet another example of the delivery plan before being updated. In this example, a vehicle T11 leaves a depot S0 to pick up a package(s) at a destination A11, and a vehicle T12 leaves the depot S0 to pick up a package(s) at a destination B11. It is assumed that the maximum payload capacity of each of the vehicles T11 and T12 is three packages.

At this time, the destination A11 has requested pickup of two packages, so that the specified capacity for the destination A11 is two packages. In addition, the destination B11 has also requested pickup of packages, so that the specified capacity for the destination B11 is also two packages.

In this example, to reduce the number of vehicles, a negotiation with a receiver at the destination A11 is carried out based on negotiation information generated by the negotiation information generation section 54.

FIG. 18 is a diagram illustrating an example of a delivery plan obtained by updating the delivery plan of FIG. 17. In this example, the negotiation with the receiver at the destination A11 has succeeded, and the specified capacity for the destination A11 has been changed to one package. This reduces the number of vehicles required for the delivery plan by one, resulting in one vehicle required.

### Third Example Embodiment

Next, the following description will discuss an example as to how to present negotiation information.

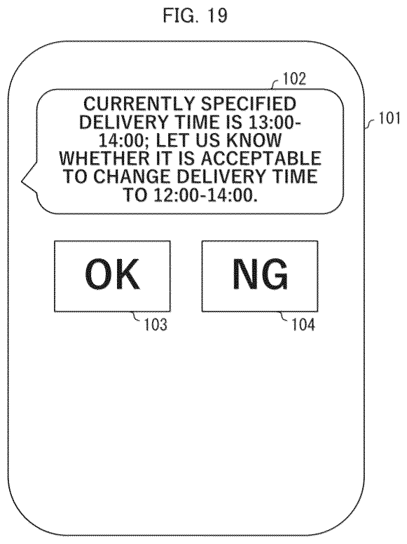

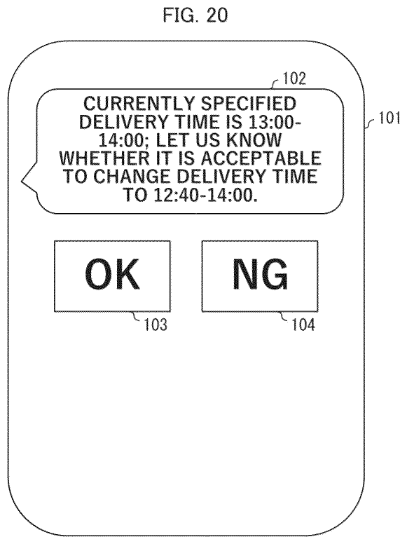

Each of FIGS. 19 and 20 is a diagram for describing an example of a format for presenting a new specified time window that has been determined. Here, an example will be described in which negotiation information is generated as a GUI displayed on the display of a smartphone. In this case, the negotiation information generation section 54 generates, for example, a command for causing an application executed on a smartphone to display an image, as described below with reference to FIGS. 19 to 22. Such a generated command or the like is sent to a smartphone of a negotiation target via the communication section 73.

Although the GUI displayed on the display of a smartphone is described herein as an example, such a GUI may be displayed on a tablet terminal, a personal computer, or the like.

FIG. 19 is a diagram for describing an example in which the time slot of the specified time window presented in the negotiation information is limited to a unit of one hour.

FIG. 19 illustrates an example in which negotiation information is displayed on a display 101 of a negotiation target's smartphone. In this example, a negotiation message 102 includes a changed time window “12:00-14:00”. If the changed time window is acceptable, the negotiation target presses an OK button 103, whereas if the changed time window is acceptable, the negotiation target presses an NG button 104. This causes the negotiation result to be sent to and received by the negotiation management section 51 via the communication section 73.

In contrast, FIG. 20 is a diagram for describing an example in which the time slot of the specified time window presented in negotiation information can also be varied for each negotiation target.

In this example, a negotiation message 102 includes a changed time window “12:40-14:00”.

As in the example of FIG. 19, the changed time slot of the specified time window may be determined in advance, or alternatively, as in the example of 18, the changed time slot of the specified time window may be changed.

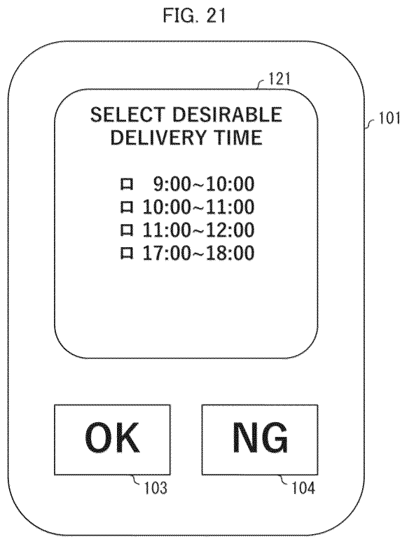

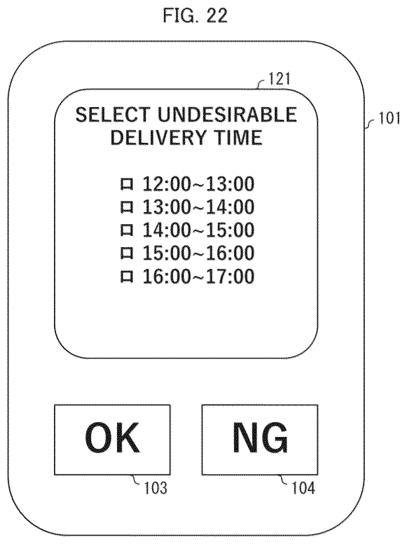

Each of FIGS. 21 and 22 is a diagram for describing an example of a format for having a negotiation target select a new specified time window.

FIG. 21 illustrates an example in which negotiation information is displayed on a display 101 of a negotiation target's smartphone. In this example, a negotiation message 102 includes multiple time windows that are selectable by the negotiation target as desired. Here, only the desirable time windows the driver wants the receiver at the destination to accept are displayed.

Then, the negotiation target puts a check mark to indicate an acceptable time window and presses an OK button 103. On the other hand, if neither of the time windows is acceptable, the negotiation target presses an NG button 104. This causes the negotiation result to be sent to and received by the negotiation management section 51 via the communication section 73. Thus, the negotiation information may present multiple options of the time window or the capacity, and invite the receiver at the destination targeted for negotiation to specify an acceptable option.

In contrast, in FIG. 22, the negotiation message 102 includes multiple options of the time window that are selectable as a time window undesired by the negotiation target.

Then, the negotiation target puts a check mark to indicate an unacceptable time window and presses an OK button 103. If all the time window options are acceptable, the negotiation target presses an NG button 104. Thus, the negotiation information may present multiple options of the time window or the capacity, and invite the receiver at the destination targeted for negotiation to specify an acceptable option.

For example, to a receiver at a destination expected to select only a small number of time window options as a desired time window, negotiation information may be provided as illustrated in FIG. 21. Further, for example, to a receiver at a destination expected to select a large number of time window options as a desired time window, negotiation information may be provided as illustrated in FIG. 22.

As an example, the negotiation information generation section 54 may refer to the past negotiation result(s) and predicts the number of “time window options that will be selected” by the negotiation target. Then, the negotiation information generation section 54 presents negotiation information as illustrated in FIG. 21 when the predicted number is less than a predetermined threshold, and presents negotiation information as illustrated in FIG. 22 when the predicted number is not less than the predetermined threshold.

### <Flow of Delivery Plan Generation Processing>

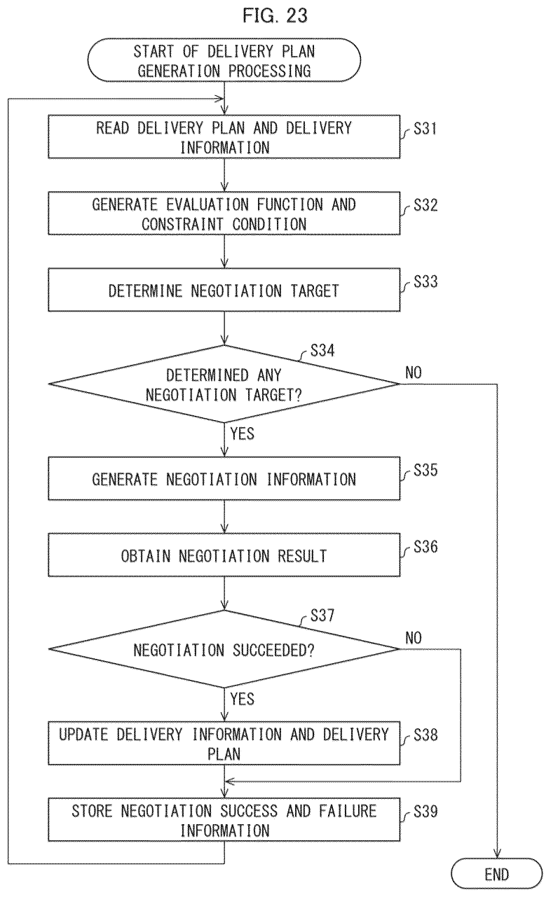

Next, the following description will discuss an example of a delivery plan generation processing carried out by the delivery plan generation apparatus 40, with reference to a flowchart of FIG. 23.

In step S31, the negotiation management section 51 reads a delivery system plan stored in the delivery plan DB 72 and delivery information stored in the delivery information DB 71. The read delivery plan and the read delivery information are provided to the time window negotiation target determination section 52 or the capacity negotiation target determination section 53.

In step S32, the time window negotiation target determination section 52 or the capacity negotiation target determination section 53 generates an evaluation function and one or more constraint conditions with reference to the delivery plan and the delivery information. Then, the time window negotiation target determination section 52 or the capacity negotiation target determination section 53 relaxes the constraint condition by means of a manipulated variable related to a change in time window, and performs a calculation to derive a route that minimizes the evaluation function under the relaxed constraint condition, to thereby generate a new delivery plan.

In step S33, the time window negotiation target determination section 52 or the capacity negotiation target determination section 53 determines, as a negotiation target, a destination that has a specified time window or a specified capacity needed to be changed in order to relax the constraint condition. This determined negotiation target is provided to the negotiation management section 51 together with the new delivery plan.

In step S34, the negotiation management section 51 determines whether or not any negotiation target has been determined, and when it is determined that a negotiation target has been determined, the operation proceeds to step S35. On the other hand, when it is determined that no negotiation target has been determined, the process is terminated.

In step S35, the negotiation information generation section 54 refers to the negotiation target and the delivery plan provided from the negotiation management section 51, and generates negotiation information, which is a time window or a carrying capacity needed to be presented to the negotiation target. As an example, the negotiation information may be generated as a GUI displayed on a display of a personal computer or a smartphone. For example, the negotiation information is generated as a GUI described above with reference to FIGS. 19 to 22.

In a case where there are a plurality of negotiation targets determined by the time window negotiation target determination section 52 or the capacity negotiation target determination section 53, a time window or a carrying capacity needed to be presented to each negotiation target is generated as negotiation information.

In step S36, the negotiation management section 51 obtains a negotiation result that is a negotiation target's response to the negotiation information generated in step S35. For example, the negotiation result may be received by the negotiation management section 51 via the communication section 73.

In step S37, the negotiation management section 51 refers to the negotiation result obtained in step S36 and determines whether or not the negotiation has succeeded.

When it is determined that the negotiation has succeeded in step S37, the operation proceeds to step S38, in which the negotiation management section 51 updates the delivery information and the VRP solving section updates the delivery plan.

On the other hand, when it is determined in step S37 that the negotiation has failed, the process in step S38 is skipped.

In step S39, the negotiation management section 51 stores the negotiation success and failure information.

After the process in step S39, the operation returns to step S31, and the subsequent processes are repeatedly executed. That is, the processes are repeated until it is determined in step S34 that no negotiation target has been determined.

Alternatively, when it is determined in step S34 that no negotiation target has been determined, the constraints expressed by Expressions M5 and M6 may be relaxed, and the operation returns to step S31. In this case, for example, the constraints may be relaxed by changing the value of “M” in Expressions M5 and M6 by increasing or decreasing the value.

Alternatively, in a case where the negotiation management section 51 is configured to check for a delivery start time, the operation may be forcibly terminated 30 minutes before the delivery start time, for example.

In this way, the delivery plan generation processing is executed.

### [Variations]

The foregoing description has discussed examples in which the time window negotiation target determination section 52 and the capacity negotiation target determination section 53 determine negotiation targets separately. That is, the time window negotiation target determination section 52 relaxes the constraint condition by means of the manipulated variable related to the change in time window, and the capacity negotiation target determination section 53 relaxes the constraint condition by means of the manipulated variable related to the change in carrying capacity.

However, the time window negotiation target determination section 52 and the capacity negotiation target determination section 53 may be integrally provided as one negotiation target determination section. In this case, the one negotiation target determination section performs a calculation to derive a route that minimizes the evaluation function under constraint conditions relaxed by means of both the manipulated variable related to the change in time window and the manipulated variable related to the change in carrying capacity, to thereby generate a new delivery plan.

In this way, a negotiation to change a specified time window and a negotiation to change a specified capacity may be carried out at the same time.

### Software Implementation Example

Some or all of the functions of each of the information processing apparatus 20 and the delivery plan generation apparatus 40 may be implemented by hardware such as an integrated circuit (IC chip), or may be alternatively implemented by software.

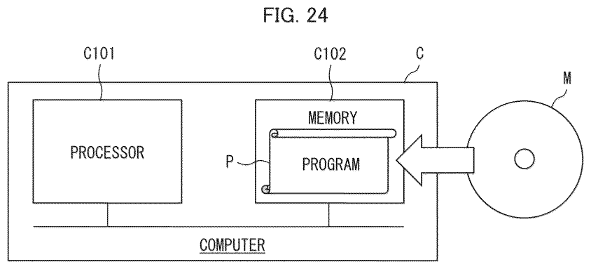

In the latter case, the information processing apparatus 20 and the delivery plan generation apparatus 40 are implemented by, for example, a computer that executes instructions of a program that is software implementing the foregoing functions. FIG. 24 illustrates an example of such a computer (hereinafter, referred to as “computer C”).

The computer C includes at least one processor C101 and at least one memory C102. The memory C102 stores a program P for causing the computer C to operate as the information processing apparatus 20 and the delivery plan generation apparatus 40. The processor C101 of the computer C retrieves the program P from the memory C102 and executes the program P, so that the functions of the information processing apparatus 20 and the delivery plan generation apparatus 40 are implemented.

As the processor C101, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. The memory C102 can be, for example, a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C may further include a communication interface via which data is transmitted to and received from another apparatus. The computer C can further include an input/output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### [Additional Remark 1]

The present invention is not limited to the above example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

Some of or all of the foregoing example embodiments can also be described as below. Note, however, that the present invention is not limited to the following supplementary notes.

### (Supplementary Note 1)

An information processing apparatus including:

determination means for determining a destination targeted for negotiation from among a plurality of destinations by solving a delivery planning problem including one or more constraint conditions, the one or more constraint conditions being associated with at least one of a capacity and a time window, the one or more constraint conditions being expressed by using a manipulated variable defined for each destination; and

output means for outputting information including a negotiation description for the destination determined by the determination means.

### (Supplementary Note 2)

The information processing apparatus according to Supplementary note 1, wherein, from among the plurality of destinations, the determination means determines, as the destination targeted for negotiation, a destination associated with at least one of the one or more constraint conditions expressed by using the manipulated variable defined for each destination.

### (Supplementary Note 3)

The information processing apparatus according to Supplementary note 1 or 2, wherein the delivery planning problem solved by the determination means includes an evaluation function or a constraint condition including information that is associated with at least one of the plurality of destinations and is other than the capacity or the time window.

### (Supplementary Note 4)

The information processing apparatus according to Supplementary note 3, wherein the constraint condition or the evaluation function includes a constraint regarding a probability of success in negotiation with a negotiation target.

### (Supplementary Note 5)

The information processing apparatus according to Supplementary note 3 or 4, wherein the constraint condition or the evaluation function includes a constraint regarding a time required for negotiation with a negotiation target.

### (Supplementary Note 6)

The information processing apparatus according to any one of Supplementary notes 3 to 5, wherein the constraint condition or the evaluation function includes a constraint regarding a consideration required for negotiation with a negotiation target.

### (Supplementary Note 7)

The information processing apparatus according to any one of Supplementary notes 1 to 6, wherein the one or more constraint conditions includes a constraint condition regarding only the capacity, out of the capacity and the time window.

### (Supplementary Note 8)

The information processing apparatus according to any one of Supplementary note 1 to 7, further including an obtaining section that obtains a negotiation result with the destination targeted for negotiation,

wherein the determination means refers to the negotiation and updates a constraint condition corresponding to the negotiation result.

### (Supplementary Note 9)

The information processing apparatus according to Supplementary note 8, wherein the obtaining section stores, for each negotiation target, negotiation success and failure information indicating success or failure in negotiation with reference to the negotiation result.

### (Supplementary Note 10)

The information processing apparatus according to any one of Supplementary notes 1 to 4, wherein the output means generates output data including the negotiation description for the destination targeted for negotiation and provides the generated output data to the destination targeted for negotiation.

### (Supplementary Note 11)

The information processing apparatus according to Supplementary note 10, wherein the negotiation description presents a plurality of options of the time window or a plurality of options of the capacity, and invites a receiver at the destination targeted for negotiation to specify an acceptable option.

### (Supplementary Note 12)

The information processing apparatus according to Supplementary note 10, wherein the negotiation description presents a plurality of options of the time window or a plurality of options of the capacity, and invites a receiver at the destination targeted for negotiation to specify an unacceptable option.

### (Supplementary Note 13)

An information processing method including: determining a destination targeted for negotiation from among a plurality of destinations by solving a delivery planning problem including one or more constraint conditions, the one or more constraint conditions being associated with at least one of a capacity and a time window, the one or more constraint conditions being expressed by using a manipulated variable defined for each destination; and

outputting information including a negotiation description for the determined destination.

### (Supplementary Note 14)

A program for causing a computer to function as an information processing apparatus including:

determination means for determining a destination targeted for negotiation from among a plurality of destinations by solving a delivery planning problem including one or more constraint conditions, the one or more constraint conditions being associated with at least one of a capacity and a time window, the one or more constraint conditions being expressed by using a manipulated variable defined for each destination; and

output means for outputting information including a negotiation description for the destination determined by the determination means.

### [Additional Remark 3]

Furthermore, some of or all of the above example embodiments can also be expressed as below.

An information processing apparatus including at least one processor, the at least one processor including:

a process of determining a destination targeted for negotiation from among a plurality of destinations by solving a delivery planning problem including one or more constraint conditions, the one or more constraint conditions being associated with at least one of a capacity and a time window, the one or more constraint conditions being expressed by using a manipulated variable defined for each destination; and

an output process of outputting information including a negotiation description for the destination determined by the determination means.

Note that the information processing apparatus may further include a memory, which may store therein a program for causing the at least one processor to carry out the obtaining process and the output sequence generation process. Alternatively, the program may be stored in a computer-readable, non-transitory, tangible storage medium.

### REFERENCE SIGNS LIST

20 Information processing apparatus
21 Determination section
22 Output section
40 Delivery plan generation apparatus
50 Control section
51 Negotiation management section
52 Time window negotiation target determination section
53 Capacity negotiation target determination section
54 Negotiation information generation section
71 Delivery information DB
72 Delivery plan DB
73 Communication section

What is claimed is:

1. An information processing apparatus comprising at least one processor, the at least one processor carrying out:
a determination process of determining a destination targeted for negotiation from among a plurality of destinations by solving a delivery planning problem including one or more constraint conditions, the one or more constraint conditions being associated with at least one of a capacity and a time window, the one or more constraint conditions being expressed by using a manipulated variable defined for each destination; and
an output process of outputting information including a negotiation description for the destination determined in the determination process.

2. The information processing apparatus according to claim 1, wherein, in the determination process, from among the plurality of destinations, the at least one processor determines, as the destination targeted for negotiation, a destination associated with at least one of the one or more constraint conditions expressed by using the manipulated variable defined for each destination.

3. The information processing apparatus according to claim 1, wherein the delivery planning problem solved by the at least one processor in the determination process includes an evaluation function or a constraint condition including information that is associated with at least one of the plurality of destinations and is other than the capacity or the time window.

4. The information processing apparatus according to claim 3, wherein the constraint condition or the evaluation function includes a constraint regarding a probability of success in negotiation with a negotiation target.

5. The information processing apparatus according to claim 3, wherein the constraint condition or the evaluation function includes a constraint regarding a time required for negotiation with a negotiation target.

6. The information processing apparatus according to claim 3, wherein the constraint condition or the evaluation function includes a constraint regarding a consideration required for negotiation with a negotiation target.

7. The information processing apparatus according to claim 1, wherein the one or more constraint conditions includes a constraint condition regarding only the capacity, out of the capacity and the time window.

8. The information processing apparatus according to claim 1, wherein
the at least one processor further carries out an obtaining process of obtaining a negotiation result with the destination targeted for negotiation, and
in the determination process, the at least one processor refers to the negotiation result and updates a constraint condition corresponding to the negotiation result.

9. The information processing apparatus according to claim 8, wherein in the obtaining process, negotiation success and failure information indicating success or failure in negotiation with reference to the negotiation result is stored for each negotiation target.

10. The information processing apparatus according to claim 1, wherein in the output process, the at least one processor generates output data including the negotiation description for the destination targeted for negotiation and provides the generated output data to the destination targeted for negotiation.

11. The information processing apparatus according to claim 10, wherein the negotiation description presents a plurality of options of the time window or a plurality of options of the capacity, and invites a receiver at the destination targeted for negotiation to specify an acceptable option.

12. The information processing apparatus according to claim 10, wherein the negotiation description presents a plurality of options of the time window or a plurality of options of the candidate capacity, and invites a receiver at the destination targeted for negotiation to specify an unacceptable option.

13. An information processing method comprising:
determining, by at least one processor, a destination targeted for negotiation from among a plurality of destinations by solving a delivery planning problem including one or more constraint conditions, the one or more constraint conditions being associated with at least one of a capacity and a time window, the one or more constraint conditions being expressed by using a manipulated variable defined for each destination; and
outputting, by the at least one processor, information including a negotiation description for the determined destination.

14. A computer-readable non-transitory storage medium storing a program for causing a computer to carry out:
a determination process of determining a destination targeted for negotiation from among a plurality of destinations by solving a delivery planning problem including one or more constraint conditions, the one or more constraint conditions being associated with at least one of a capacity and a time window, the one or more constraint conditions being expressed by using a manipulated variable defined for each destination; and
an output process of outputting information including a negotiation description for the destination determined in the determination process.
